(19) United States
(12) Patent Application Publication
(10) Pub. No.: US 2017/0111388 A1
(43) Pub. Date: Apr. 20, 2017

(54) Centralized and Automated Recovery

(71) Applicant: McAfee, Inc., Santa Clara, CA (US)

(72) Inventors: Kunal Mehta, Hillsboro, OR (US); Dmitri Rubakha, Santa Clara, CA (US); Carl D. Woodward, Santa Clara, CA (US); Steven L. Grobman, El Dorado Hills, CA (US); Adrian R. Pearson, Hillsboro, OR (US); Faraz A. Siddiqi, Portland, OR (US)

(21) Appl. No.: 15/088,931

(22) Filed: Apr. 1, 2016

Related U.S. Application Data
(60) Provisional application No. 62/243,865, filed on Oct. 20, 2015.

(51) Int. Cl. H04L 29/06

(52) U.S. Cl. CPC H04L 63/1441

(57) ABSTRACT

A system for securing electronic devices includes a processor, a storage medium communicatively coupled to the processor, and a secured storage communicatively coupled to the client. The system further includes a client application including computer-executable instructions on the medium. The instructions are readable by the processor. The application is configured to manage a trusted image of software of a client in a secured storage and, upon a signal indicating malware on the client, restore the trusted image to the client independent of an operating system and user processes of the client.

### CROSS-REFERENCE TO RELATED APPLICATIONS

This application claims priority from U.S. Provisional Application No. 62/243,865, filed Oct. 20, 2015, entitled “Centralized and Automated Recovery,” the contents of which is incorporated herein by reference.

### TECHNICAL FIELD

The present disclosure pertains to the field of electronic device security and, more particularly, to a system and method for centralized and automated recovery.

### DESCRIPTION OF RELATED ART

When compromised, electronic content might be restored to servers, computers, and other machines. Attempts to recover and restore electronic content may include reimaging each such machine. The attempts to recover and restore electronic content may be made from centralized servers or machines. The centralized servers or machines themselves may be compromised and restoration of client machines may be performed by hand. The restoration effort for many different clients may share network bandwidth. Some restoration may be performed offline, without taking advantage of the network.

### BRIEF DESCRIPTION OF THE DRAWINGS

For a more complete understanding of embodiments of the present disclosure and its features and advantages, reference is now made to the following description, taken in conjunction with the accompanying drawings, in which:

FIG. 1 is a block diagram illustrating an example embodiment of a system for centralized and automated recovery, according to embodiments of the present disclosure;

FIG. 2 is a more detailed illustration of elements of a system and their operation, according to embodiments of the present disclosure; and

FIG. 3 is a flow diagram illustrating an embodiment of a method for centralized and automated recovery, according to embodiments of the present disclosure.

### DETAILED DESCRIPTION

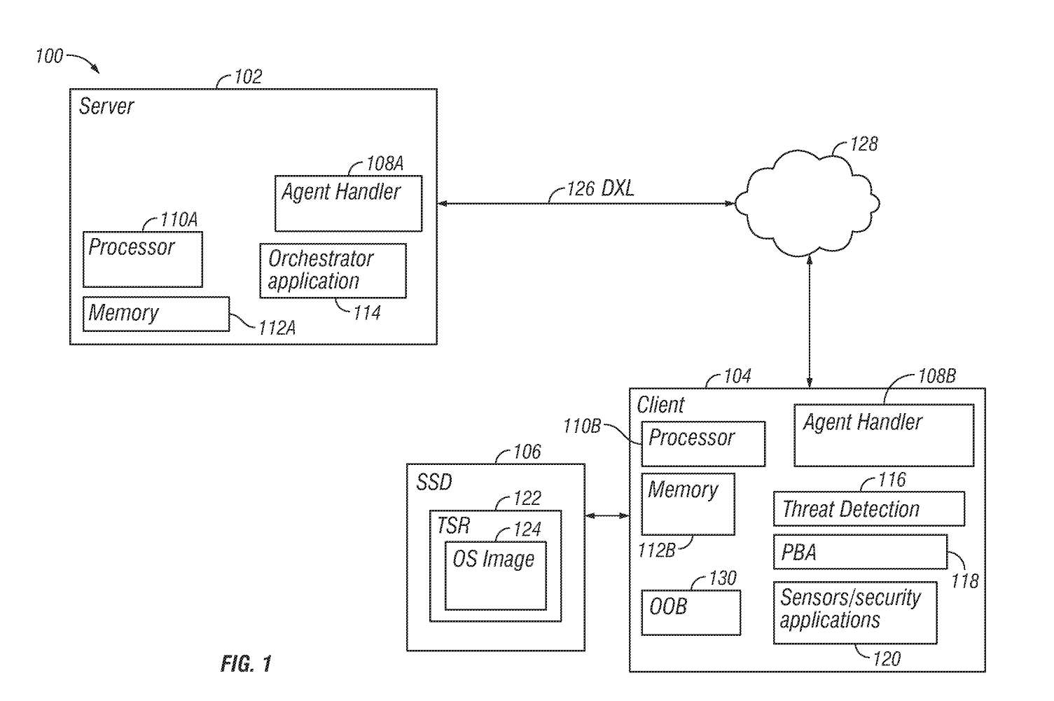

FIG. 1 is a block diagram illustrating an example embodiment of a system 100 for centralized and automated recovery, according to embodiments of the present disclosure. In one embodiment, the system may provide centralized and automated recovery through out-of-band techniques. In another embodiment, system 100 may provide centralized and automated recovery through a trusted process. In yet another embodiment, system 100 may provide recovery based upon sensors. System 100 may include any suitable number and configuration of components. Although certain elements are illustrated in FIG. 1, system 100 may include more or fewer components. Moreover, although certain elements of system 100 are described herein as configured to perform particular functionality, such functionality may be implemented by other suitable portions of system 100.

System 100 may include one or more centralized servers, such as server 102, that manage a plurality of clients, such as client 104. Client 104 may also be referred to as an endpoint. Multiple clients, particularly virtual clients such as virtual machines, may reside on a single physical endpoint. Server 102 and client 104 may communicate through any suitable network 128 and network configuration. In terms of protocol, server 102 and client 104 may communicate through a data exchange layer (DXL) 126. Moreover, server 102 and client 104 may communicate through an out-of-band (OOB) module 130, subsystem, or other mechanism located with client 104. OOB module 130 may include active management technology (AMT).

Furthermore, server 102 and client 104 may communicate through individual modules or software within the respective server and client. An agent handler 108, located within a suitable one of server 102 and client 104 or other network element, may provide a command or application programing interface for portions of server 102 and client 104 to communicate. This may include a deep command plug-in.

Server 102 may include any suitable number and kind of components. In one embodiment, the server may include an orchestrator application 114. Orchestrator application 114 may include an ePolicy Orchestrator (EPO) to control management and automated recovery of clients. Orchestrator application 114 may include any suitable components, such as an automatic response module and an threat detection and active response module. The automatic response module may invoke rebooting and restoration on clients through, for example, OOB 130. The automatic response module may make such invocations through, for example, agent handler 108. The threat detection and active response module may communicate with client 104 to determine the status of client 104. Based upon such statuses or conditions observed, the threat detection and active response module may inform the automatic response module that a given client or clients 104 need to be rebooted, restored, or otherwise recovered.

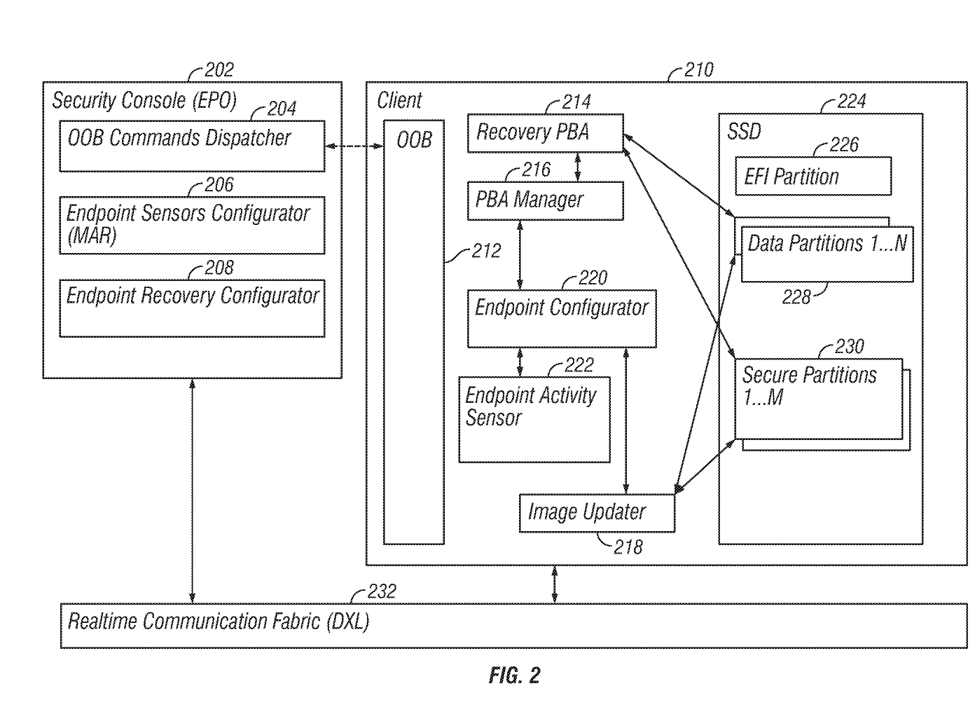

Client 104 may be implemented in any suitable manner. For example, client 104 may include modules for OOB or AMT operation and communication. Furthermore, client 104 may include modules for determining that malware has been encountered or that the client has otherwise been compromised. In addition, client 104 may include or be communicatively coupled to secured storage. Such modules are illustrated in further detail in FIG. 2, discussed in further detail below.

In client 104, any suitable modules may be used as sensors 120 or security applications for determining that malware has been encountered by client 104 or that client 104 has otherwise been compromised. For example, the client may include an end-point protection module. The end-point protection module may include whitelisting, anti-malware routines, scanning, behavior analysis, anti-virus engines, anti-spam filtering, software firewalling, or other suitable features. The sensors may be routed through use of an endpoint threat detection and response tool 116 or module, such as active response.

Client 104 may also include Pre-Boot Applications (PBA) for recovery. These may cause restoration of an image of an operating system or other client components upon a cold boot, hard boot, warm boot, or forced boot through OOB 130. The restoration may be performed before the boot to operating system for the client is performed.

Client 104 may include threat detection and active response features for behavior monitoring. These features may analyze behaviors or other actions on the client that, while not originating from entities known to be malicious, are nevertheless suspicious. The threat detection and active response features may implement zero-day attack prevention. The threat detection and active response features might be controlled through a local agent on the client.

The secured storage may include, for example, a solid state disk (SSD) 106. In one embodiment, the storage device may be implemented as a self-encrypting device (SED). Reads and writes of content of the storage device may be made from, for example, applications in the local or remote hosts. The storage device may include an Extensible Firmware Interface (EFI) standard partition, wherein access to read-only portions (TSR) 122 of the device is only allowed upon certain security procedures. These procedures might include, for example, storing data writes in the storage device until the write can be authorized, whereupon the stored data may be written to the final destination. The procedures might also include checking a signature of the data to be written. These read-only portions may include known, good images 124 of an operating system or other applications and settings to which the client might be restored. The image of the operating system might reside separately from these known, good images in the secured storage.

The features, applications, modules, and other elements of system 100, server 102, and client 104, both as shown in FIG. 1 and FIG. 2, below, may be implemented in any suitable manner, such as by a program, application, script, function, library, code, software, firmware, hardware, reconfigurable circuitry, or other mechanisms for carrying out the functionality described in the present disclosure. Moreover, these may be implemented in any suitable portion of system 100. For example, some portions of client 104 may be implemented in firmware of storage device 106. Server 102 and client 104 may include any suitable electronic device, such as a server, blade, computer, laptop, mobile device, or tablet.

Various portions of system 100 may include a processor 110 communicatively coupled to a memory 112. In particular, applications, modules, and other components of server 102 and client 104 may execute on a portion of system 100, such as firmware of storage device 106, wherein the components may include instructions loaded on memory 112 to be read and executed by processor 110. The components of server 102 and client 104, when loaded and executed by processor 110, may perform the functionality described in this disclosure.

Memory 112 may be in the form of physical memory or pages of virtualized memory. Processor 110 may comprise, for example, a microprocessor, microcontroller, digital signal processor (DSP), application specific integrated circuit (ASIC), or any other digital or analog circuitry configured to interpret and/or execute program instructions and/or process data. In some embodiments, processor 110 may interpret and/or execute program instructions and/or process data stored in memory 112. Memory 112 may be configured in part or whole as application memory, system memory, or both. Memory 112 may include any system, device, or apparatus configured to hold and/or house one or more memory modules. Each memory module may include any system, device or apparatus configured to retain program instructions and/or data for a period of time (e.g., computer-readable storage media). Instructions, logic, or data for configuring the operation of system 100 may reside in memory for execution by the processor.

Processor 110 may execute one or more code instruction(s) to be executed by the one or more cores of processor 110. The processor cores may follow a program sequence of instructions indicated by the code instructions. Each code instruction may be processed by one or more decoders of the processor. The decoder may generate as its output a micro operation such as a fixed width micro operation in a predefined format, or may generate other instructions, microinstructions, or control signals which reflect the original code instruction. Processor 110 may also include register renaming logic and scheduling logic, which generally allocate resources and queue the operation corresponding to the convert instruction for execution. After completion of execution of the operations specified by the code instructions, back end logic within processor 110 may retire the instruction. In one embodiment, processor 110 may allow out of order execution but requires in order retirement of instructions. Retirement logic within the processor may take a variety of forms as known to those of skill in the art (e.g., re-order buffers or the like). The processor cores of processor 110 are thus transformed during execution of the code, at least in terms of the output generated by the decoder, the hardware registers and tables utilized by the register renaming logic, and any registers modified by the execution logic

FIG. 2 is a more detailed illustration of elements of system 100 and their operation, according to embodiments of the present disclosure. A security console 202 may include orchestrator application 114, an OOB or AMT Command Dispatcher 204, an Endpoint Sensors Configurator 206, and an Endpoint Recovery Configurator 208.

Orchestrator application 114 may be executed on a security console 202 on server 102 for an administrator of system 100 and network of clients 104. Commands to reboot or restore images on a given client, such as client 210, may be issued by OOB or AMT Command Dispatcher 204. The commands may be issued through OOB or AMT. Configurator 206 may define settings, thresholds, or other parameters for client or endpoint sensors. These parameters may be transmitted to clients 210. These parameters may define operation of sensors in clients 210. The parameters may be updated periodically, on-demand, or at other suitable times. Configurator 208 may define procedures, conditions, or other parameters by which clients 210 are to restore operating system images or settings. This restoration may be triggered upon conditions defined by configurator 206. The parameters may include an identification of an image or settings on a local secured storage, when the restoration should be performed, or other suitable information. DXL layer 232 connecting the server and client may include a real-time communication fabric.

A secured storage, such as SSD 224, may be included within client 210 or communicatively coupled thereto. SSD 224 may include an EFI partition 226, data partitions 228, and secured partitions 230. EFI partition 226 may include a partition from which PBA operations are to be sourced. Data partitions 228 may include any suitable number, kind, and size of partitions 228 for which users or kernels of the client 210 may use for data, operating system operations, etc. Secured partitions 230 may include any suitable number, kind, and size of partitions that are read-only. Secured partitions 230 may be inaccessible to users, operating systems, or kernels of client 210. Secured partitions 230 might be written to or updated only during pre-boot through the AMT or OOB by way of authenticated recovery PBA present in an EFI partition. The secured partitions may include trusted operating system images, settings, or other secured data, such as image 124. Malware operating within an operating system environment on client 210 might be unable to access secured partitions 230, as access is reserved for OOB or AMT. Consequently, image 124 might not be modified by malware. Moreover, as SSD 224 is local to client 210, network bandwidth might not be needed from the central server to multiple clients 210 to restore the image from SSD 224.

Writes to SSD 224 might be signed and authenticated using public and private key pairs. The appropriate keys might only be held by a trusted application operating outside of operating system kernels that can be infected with malware, such as EFI partition 226. As discussed above, EFI partition 226 might be locked in firmware of SSD 224 and thus not visible to applications otherwise operating on client 210. Invisibility might be preserved through assignment of EFI partition 226 to drive designations that are beyond the range of disks or partitions usable by applications running on client 210, but may be accessible through OOB 212.

Client 210 may include an endpoint configurator 220. Configurator 220 may configure endpoint sensor activity and reporting thereof. The endpoint sensor activity may be configured according to instructions, parameters, or other information received from server 102. Client 210 may include one or more endpoint activity sensors 222. Sensors 222 may be implemented by software agents that may monitor behaviors in execution of software on the client, in network activity, etc. Furthermore, client 210 may include an image updater 218. Image updater 218 may update, synchronously or asynchronously, the contents of secured and data partitions 228, 230. Furthermore, the client may include a PBA manager 216 and recovery PBA 214 to configure such contents for secured recovery.

Some solutions for recovery may include reimaging entire systems from backup. This may solve a large scale disaster, compromise, or loss of information. However, such a recovery might be thwarted by the same malware that caused a problem. An operating system of clients might not be in a state to boot at all, and thus it may be difficult to boot the client from a remote station. The process might be a large undertaking, and thus require significant recovery downtime, during which equipment is not being used for its designated purpose. If an image of client installations is centrally located, network bandwidth overhead or bottlenecks may slow recovery. After recovery, there is no assurance that the client install is any safer than before the recovery. Furthermore, some users might have to take machines to another location for service. In addition, technical staff might have to individually administer hundreds or thousands of clients through the restoration process.

System 100 may solve one or more of these challenges by restoring machines such as clients 104 without requiring technical staff support to perform the restoration. In one embodiment, restoration for client 104 may be made from an image stored locally to client 104. For example, such an image may be stored in secured storage 106, located within or communicatively coupled to client 104. In a further embodiment, the image may be hidden on the client environment. In another, further embodiment, the image may be protected.

Restoration may be initiated by any suitable process. In one embodiment, restoration may be initiated by sensors 120 on the client. In another embodiment, restoration may be triggered by a centrally located administrator, such as one using orchestrator application 114. In such embodiments, restoration may be performed through an out-of-band channel from server 102 to client 104 that cannot be interfered with or prevented by malware. In yet another embodiment, restoration may be performed independent of the operating system of client 104. In still yet another embodiment, restoration may be performed independent of the state of client 104. Restoration may be automatic in response to a suitable trigger. Out-of-band initiation of the restoration process may include, for example, communication through OOB or AMT. Central administration may be made through a unified application or console.

Secured storage in SSD 106 may be trusted, secure and hidden. Only a trusted recovery agent or management tool might access an image 124. Furthermore, OOB 130 may serve as an out-of-band communication channel to trigger restoration in a way that cannot be preventive or disrupted by malware. Sensors 120 may report incidence of compromise or malware attacks to orchestrator application 114. Orchestrator application 114 may allow automated (in response to sensor reports) or manually initiated restoration using over the out-of-band communication channel of OOB 130. The trusted or known good recovery environment image 124 stored in SSD 106 may be independent of the operating system as-installed or operating on client 104.

In operation, a golden or trusted image 124 of content for client 104 may be stored within a secured or read-only area of SSD 106. The content of image 124 may include, for example, operating systems, installed software, settings, or other content for client 104. Endpoint sensors 120 may be configured and activated on client 104. These sensors 120 may be configured by orchestrator application 114 to detect malicious activity on client 104. Upon a determination of malicious activity on client 104, sensors 120 may report to orchestrator application 114 independent of operating systems, user processes, or kernels of client 104. The report may specify, in real-time over the DXL 126 fabric to orchestrator application 114, that client 104 has been compromised. Orchestrator application 114 may send an out-of-band reboot command to reported client 104. The reboot command may include parameters specific to the recovery operation to be performed. For example, the parameter may designate an operation type such as a “system restore” or “system re-image.”

OOB 130 on client 104 may receive the reboot command with system restore parameter. OOB 130 may store the restore parameter and configuration securely in a UEFI environment, such as EFI partition 226, and force out-of-band machine reboot. Upon the reboot, system 100 may boot into trusted and known good UEFI environment and pre-boot recovery applications will be invoked. PBA manager 216 and recovery PBA 214 may check the UEFI restore parameter and configurations to see whether there is a need to restore the machine into a known, trusted state. If a restore flag is set, then PBA manager 216 and recovery PBA 214 may invoke restore logic by securely reading image 124 from secured partitions 230 and restore the images therein to the normal data partitions 228. Once the restore operation is completed, the PBA manager 216 and recovery PBA 214 may reset all the flag and reboot the machine will newly recovered or restored OS.

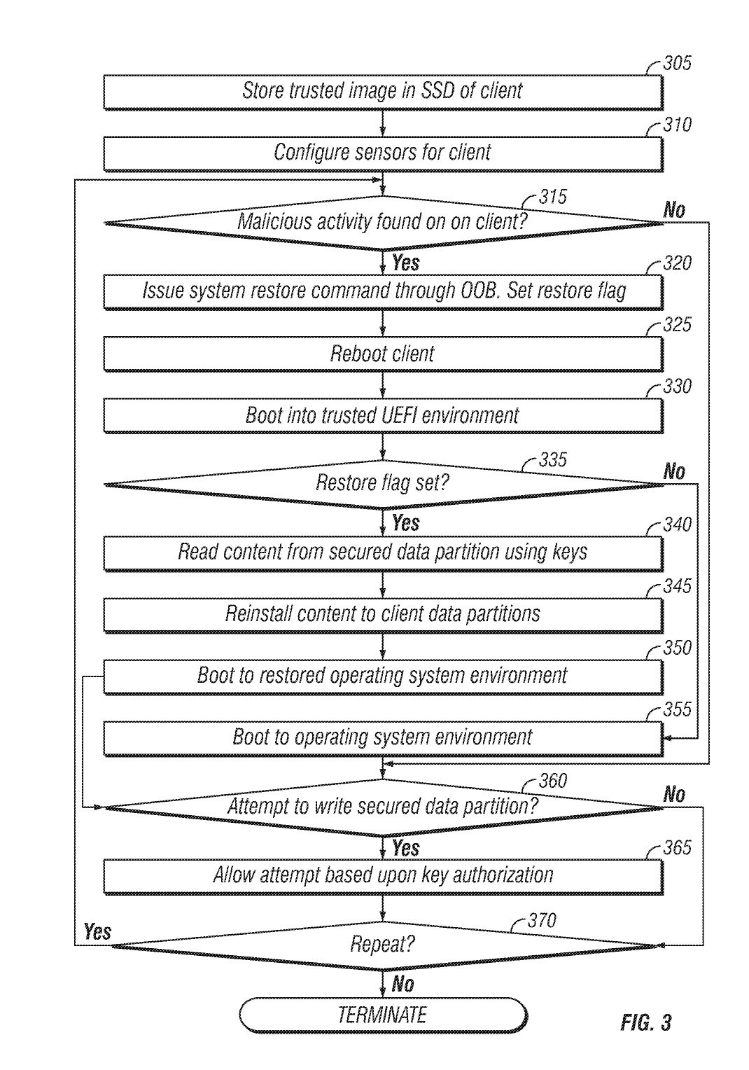

FIG. 3 is a flow diagram illustrating an embodiment of a method for centralized and automated recovery, according to embodiments of the present disclosure. Method 300 may be implemented by any of the elements of FIGS. 1-2 shown above. For example, various portions of method 300 may be performed by SSD 106, server 102, or client 104. The steps of method 300 may begin at any suitable point, including 305. Furthermore, the steps of method 300 may be optionally repeated, looped, recursively executed, executed in various order, or omitted as necessary. Different steps of method 300 may be executed in parallel with other steps of method 300. In additional, further steps may be executed during execution of method 300, wherein such further steps are not shown in FIG. 3 but are described with respect to FIGS. 1 and 2 or would be apparent to one of skill. Execution of method 300 may be performed entirely or in part by execution of instructions from a memory by a processor.

At 305, a trusted image of protected content may be stored. The image may include settings, an operating system, or application installations. The image may be stored in a protected partition in, for example, an SSD. The protected partition may require authentication to write to or read from stored content. The authentication may require use of public-private keys to verify that only an authorized entity successfully makes the access. The protected partition may be inaccessible or invisible to operating systems and processes on operating systems on the client. The protected partition may be accessed through AMT in an out-of-band manner. The storage of the trusted image may be performed at the request of a server.

At 310, sensors or monitoring applications for a client may be configured. The sensors may be configured from the server. The sensors may be configured with settings that identify malicious behavior, compromise of the client, or compromise of software such as operating systems or security software on the client.

At 315, it may be determined whether malicious activity has been found on the client. If so, method 300 may proceed to 320. Otherwise, method 300 may proceed to 360.

At 320, it may be determined that the client or its content has been compromised. A system restore command may be issued. The command may be issued from the client itself or from the server, which has received a report that the client was compromised. The command may be issued through OOB. A restore flag may be set, indicating that, after reboot to secured applications, the restore operation should be conducted.

At 325, the client may be rebooted. The reboot may be performed via OOB.

At 330, the client may be booted into a secured environment, such as a UEFI environment. The UEFI environment may handle restoration of the image to the data partitions of the client. The UEFI environment may be located in the SSD.

At 335, it may be determined whether the restoration flag was set, for example, in the previous operation of 320. If so, method 300 may proceed to 340. Otherwise, method 300 may proceed to 355.

At 340, content may be read from secured data partitions that includes the trusted image. The access of the secured data partitions may be made using encryption such a public-private key pair scheme to verify identity of the UEFI partition. The access may be made using firmware of the secured storage.

At 345, content for the client may be reinstalled. The image may be restored to the client's data partitions.

At 350, the client may be booted using the restored content. For example, the restored content may include an operating system environment to which the client is newly booted. In another example, the restored content may include applications that are to be executed after boot. Method 300 may proceed to 360.

At 355, the client may be booted to the previously existing operating system environment. Method 300 may proceed to 360.

At 360, it may be determined whether there is an attempt to write or update data of the secured data partition. Such an attempt may include a legitimate attempt to update a trusted image or an unauthorized attempt to harm the trusted image. If such an attempt has been made, method 300 may proceed to 365. Otherwise method 300 may proceed to 370.

At 365, the entity making the attempt to write or update data of the secured data partition may be evaluated. Such an evaluation may be made with an encryption authorization using public-private key pairs. The attempt may be allowed or disallowed based upon whether the entity is authorized.

At 370, method 300 may optionally repeat or terminate. Method 300 may repeat by proceeding to, for example, 310, 315, or 360.

Embodiments of the present disclosure include at least one non-transitory machine readable storage medium. In these embodiments, the comprising computer-executable instructions may be carried on the machine readable medium. In these embodiments, the instructions may readable by a processor. In these embodiments, the instructions, when read and executed, may cause the processor to manage a trusted image of software of a client in a secured storage communicatively coupled to the client. In combination with any of the above embodiments, the processor may further be caused to, upon a signal indicating malware on the client, restore the trusted image to the client independent of an operating system and user processes of the client. In combination with any of the above embodiments, the processor may further be caused to monitor execution of the client to determine whether malware is indicated during the execution of the client. In combination with any of the above embodiments, the processor may further be caused to, based upon results of determining whether malware is indicated during the execution of the client, send a notification to a server concerning the malware. In combination with any of the above embodiments, the signal indicating malware results from the notification may be sent to the server. In combination with any of the above embodiments, the processor may be further caused to restrict visibility of the trusted image to user processes and operating system kernels of the client. In combination with any of the above embodiments, the processor may be further caused to receive the signal indicating malware through a communication channel bypassing the operating system and user processes of the client. In combination with any of the above embodiments, the processor may be further caused to restore the trusted image by receiving a reboot command with a restore parameter, storing the restore parameter, forcing a reboot of the client into a trusted environment, and, based upon the restore parameter, restoring the trusted image. In combination with any of the above embodiments, the processor may be further caused to restore the trusted image by receiving a reboot command with a restore parameter, storing the restore parameter, forcing a reboot of the client into a trusted environment, based upon the restore parameter, securely reading the trusted image from the secured storage, restoring the trusted image to data partitions of the secured storage accessible by the operating system, and resetting the restore parameter.

Embodiments of the present disclosure include a system for securing electronic devices. The system may include an application, at least one non-transitory machine readable storage medium communicatively coupled to the application, and a client application comprising computer-executable instructions on the medium. The instructions may be readable by the application. The application may manage a trusted image of software of a client in a secured storage communicatively coupled to the client. In combination with any of the above embodiments, the application may further be caused to, upon a signal indicating malware on the client, restore the trusted image to the client independent of an operating system and user processes of the client. In combination with any of the above embodiments, the application may further be caused to monitor execution of the client to determine whether malware is indicated during the execution of the client. In combination with any of the above embodiments, the application may further be caused to, based upon results of determining whether malware is indicated during the execution of the client, send a notification to a server concerning the malware. In combination with any of the above embodiments, the signal indicating malware results from the notification may be sent to the server. In combination with any of the above embodiments, the application may be further caused to restrict visibility of the trusted image to user processes and operating system kernels of the client. In combination with any of the above embodiments, the application may be further caused to receive the signal indicating malware through a communication channel bypassing the operating system and user processes of the client. In combination with any of the above embodiments, the application may be further caused to restore the trusted image by receiving a reboot command with a restore parameter, storing the restore parameter, forcing a reboot of the client into a trusted environment, and, based upon the restore parameter, restoring the trusted image. In combination with any of the above embodiments, the application may be further caused to restore the trusted image by receiving a reboot command with a restore parameter, storing the restore parameter, forcing a reboot of the client into a trusted environment, based upon the restore parameter, securely reading the trusted image from the secured storage, restoring the trusted image to data partitions of the secured storage accessible by the operating system, and resetting the restore parameter.

Embodiments of the present disclosure may include a method, comprising storing a trusted image of software of a client in a secured storage communicatively coupled to the client and, upon a signal indicating malware on the client, restoring the trusted image to the client independent of an operating system and user processes of the client. In combination with any of the above embodiments, the method may include monitoring execution of the client to determine whether malware is indicated during the execution of the client, and, based upon results of determining whether malware is indicated during the execution of the client, sending a notification to a server concerning the malware. In combination with any of the above embodiments, the signal may indicate malware results from the notification sent to the server. In combination with any of the above embodiments, the method may include restricting visibility of the trusted image to user processes and operating system kernels of the client. In combination with any of the above embodiments, the method may include receiving the signal indicating malware through a communication channel bypassing the operating system and user processes of the client. In combination with any of the above embodiments, the method may include restoring the trusted image by receiving a reboot command with a restore parameter, storing the restore parameter, forcing a reboot of the client into a trusted environment, and, based upon the restore parameter, restoring the trusted image. In combination with any of the above embodiments, the method may include receiving a reboot command with a restore parameter, storing the restore parameter, forcing a reboot of the client into a trusted environment, based upon the restore parameter, securely reading the trusted image from the secured storage, restoring the trusted image to data partitions of the secured storage accessible by the operating system, and resetting the restore parameter.

Embodiments of the present disclosure may include an apparatus comprising means for storing a trusted image of software of a client in a secured storage communicatively coupled to the client and, upon a signal indicating malware on the client, restoring the trusted image to the client independent of an operating system and user processes of the client. In combination with any of the above embodiments, the apparatus may include means for monitoring execution of the client to determine whether malware is indicated during the execution of the client, and, based upon results of determining whether malware is indicated during the execution of the client, sending a notification to a server concerning the malware. In combination with any of the above embodiments, the signal may indicate malware results from the notification sent to the server. In combination with any of the above embodiments, the apparatus may include means for restricting visibility of the trusted image to user processes and operating system kernels of the client. In combination with any of the above embodiments, the apparatus may include means for receiving the signal indicating malware through a communication channel bypassing the operating system and user processes of the client. In combination with any of the above embodiments, the apparatus may include means for restoring the trusted image by receiving a reboot command with a restore parameter, storing the restore parameter, forcing a reboot of the client into a trusted environment, and, based upon the restore parameter, restoring the trusted image. In combination with any of the above embodiments, the apparatus may include means for receiving a reboot command with a restore parameter, storing the restore parameter, forcing a reboot of the client into a trusted environment, based upon the restore parameter, securely reading the trusted image from the secured storage, restoring the trusted image to data partitions of the secured storage accessible by the operating system, and resetting the restore parameter.

Program instructions may be used to cause a general-purpose or special-purpose processing system that is programmed with the instructions to perform the operations described above. The operations may be performed by specific hardware components that contain hardwired logic for performing the operations, or by any combination of programmed computer components and custom hardware components. Methods may be provided as a computer program product that may include one or more machine readable media having stored thereon instructions that may be used to program a processing system or other electronic device to perform the methods. The terms “machine readable medium” or “computer readable medium” used herein shall include any medium that is capable of storing or encoding a sequence of instructions for execution by the machine and that cause the machine to perform any one of the methods described herein. The term “machine readable medium” shall accordingly include, but not be limited to, memories such as solid-state memories, optical and magnetic disks. Furthermore, it is common in the art to speak of software, in one form or another (e.g., program, procedure, process, application, module, logic, and so on), as taking an action or causing a result. Such expressions are merely a shorthand way of stating that the execution of the software by a processing system causes the processor to perform an action or produce a result.

Although the present disclosure has been described in detail, it should be understood that various changes, substitutions, and alterations can be made hereto without departing from the spirit and the scope of the disclosure as defined by the appended claims.

What is claimed is:

1. At least one non-transitory machine readable storage medium, comprising computer-executable instructions carried on the machine readable medium, the instructions readable by a processor, the instructions, when read and executed, for causing the processor to:
manage a trusted image of software of a client in a secured storage communicatively coupled to the client; and
upon a signal indicating malware on the client, restore the trusted image to the client independent of an operating system and user processes of the client.

2. The medium of claim 1, further comprising instructions for causing the processor to:
monitor execution of the client to determine whether malware is indicated during the execution of the client; and
based upon results of determining whether malware is indicated during the execution of the client, send a notification to a server concerning the malware.

3. The medium of claim 1, further comprising instructions for causing the processor to:
monitor execution of the client to determine whether malware is indicated during the execution of the client; and
based upon results of determining whether malware is indicated during the execution of the client, send a notification to a server concerning the malware;
wherein the signal indicates malware results from the notification is sent to the server.

4. The medium of claim 1, further comprising instructions for causing the processor to restrict visibility of the trusted image to user processes and operating system kernels of the client.

5. The medium of claim 1, further comprising instructions for causing the processor to receive the signal indicating malware through a communication channel bypassing the operating system and user processes of the client.

6. The medium of claim 1, further comprising instructions for causing the processor to restore the trusted image by:
receiving a reboot command with a restore parameter;
storing the restore parameter;
forcing a reboot of the client into a trusted environment; and
based upon the restore parameter, restoring the trusted image.

7. The medium of claim 1, further comprising instructions for causing the processor to restore the trusted image by:
receiving a reboot command with a restore parameter;
storing the restore parameter;
forcing a reboot of the client into a trusted environment;
based upon the restore parameter, securely reading the trusted image from the secured storage;
restoring the trusted image to data partitions of the secured storage accessible by the operating system; and
resetting the restore parameter.

8. A system for securing electronic devices, comprising:
a processor;
at least one non-transitory machine readable storage medium communicatively coupled to the processor;
a client application comprising computer-executable instructions on the medium, the instructions readable by the processor, the application configured to:
manage a trusted image of software of a client in a secured storage communicatively coupled to the client; and
upon a signal indicating malware on the client, restore the trusted image to the client independent of an operating system and user processes of the client.

9. The system of claim 8, wherein the client application is further configured to:
monitor execution of the client to determine whether malware is indicated during the execution of the client; and
based upon results of determining whether malware is indicated during the execution of the client, send a notification to a server concerning the malware.

10. The system of claim 8, wherein the client application is further configured to:
monitor execution of the client to determine whether malware is indicated during the execution of the client; and
based upon results of determining whether malware is indicated during the execution of the client, send a notification to a server concerning the malware;
wherein the signal indicates malware results from the notification sent to the server.

11. The system of claim 8, wherein the client application is further configured to restrict visibility of the trusted image to user processes and operating system kernels of the client.

12. The system of claim 8, wherein the client application is further configured to receive the signal indicating malware through a communication channel bypassing the operating system and user processes of the client.

13. The system of claim 8, wherein the client application is further configured to restore the trusted image by:
receiving a reboot command with a restore parameter;
storing the restore parameter;
forcing a reboot of the client into a trusted environment; and
based upon the restore parameter, restoring the trusted image.

14. The system of claim 8, wherein the client application is further configured to restore the trusted image by:
receiving a reboot command with a restore parameter;
storing the restore parameter;
forcing a reboot of the client into a trusted environment;
based upon the restore parameter, securely reading the trusted image from the secured storage;
restoring the trusted image to data partitions of the secured storage accessible by the operating system; and
resetting the restore parameter.

15. A method of computer security, comprising:
managing a trusted image of software of a client in a secured storage communicatively coupled to the client; and
upon a signal indicating malware on the client, restoring the trusted image to the client independent of an operating system and user processes of the client.

16. The method of claim 15, further comprising:
monitoring execution of the client to determine whether malware is indicated during the execution of the client; and
based upon results of determining whether malware is indicated during the execution of the client, sending a notification to a server concerning the malware.

17. The method of claim 15, further comprising:
monitoring execution of the client to determine whether malware is indicated during the execution of the client; and
based upon results of determining whether malware is indicated during the execution of the client, sending a notification to a server concerning the malware;
wherein the signal indicates malware results from the notification sent to the server.

18. The method of claim 15, further comprising restricting visibility of the trusted image to user processes and operating system kernels of the client.

19. The method of claim 15, further comprising receiving the signal indicating malware through a communication channel bypassing the operating system and user processes of the client.

20. The method of claim 15, further comprising restoring the trusted image by:
receiving a reboot command with a restore parameter;
storing the restore parameter;
forcing a reboot of the client into a trusted environment; and
based upon the restore parameter, restoring the trusted image.

21. The method of claim 15, further comprising restoring the trusted image by:
receiving a reboot command with a restore parameter;
storing the restore parameter;
forcing a reboot of the client into a trusted environment;
based upon the restore parameter, securely reading the trusted image from the secured storage;
restoring the trusted image to data partitions of the secured storage accessible by the operating system; and
resetting the restore parameter.
